(19) United States
(12) Patent Application Publication
(10) Pub. No.: US 2011/0193789 A1
(43) Pub. Date: Aug. 11, 2011

(54) AIR PRESSURE BALANCE STRUCTURE FOR TOUCH PANEL

(76) Inventor: Teh-Zheng Lin, Taoyuan (TW)

(21) Appl. No.: 12/703,783

(22) Filed: Feb. 11, 2010

(51) Int. Cl. G06F 3/041

(52) U.S. Cl. 345/173

(57) ABSTRACT

An air pressure balance structure for touch panel has at least one long narrow ventilating tunnel formed vertically to a gluing frame of a resistive touch panel. The ventilating tunnel communicates an inner space of the touch panel with the outside of the touch panel so as to prevent a damage caused by difference of air pressure. By the long narrow ventilating tunnel and the adhesive material of the gluing frame, moisture and dust will be prevented from coming into the touch panel so that an inner cleanliness of the touch panel will be ensured. The ventilating tunnel also has a turning portion, the turning portion has large containing space so as to buffer the air flow and capture the moisture and dust.

### FIELD OF THE INVENTION

The present invention relates to air pressure balance structure, and particular to an air pressure balance structure for resistive touch panel.

### DESCRIPTION OF THE PRIOR ART

A normal touch panel, especially a resistive touch panel usually includes two sheets of conductive film arranged with a predetermined gap. The upper conductive film is arranged to a surface of a flexible transparent film, and the lower conductive film is arranged to a surface of a hard transparent substrate. A plurality of protruding spacers is arranged between the two conductive films so that a space is formed between the two conductive films. The gluing frame is arranged around the films to seal the substrate and the transparent film from dust and moisture.

The touch panel with sealed conductive films mentioned above is working fine under normal circumstance. While the conductive film suffers higher pressure such as during transportation in tens of thousands feet height, atmosphere pressure is about 0.1 to 0.2 ATM. The high pressure difference usually causes the seal of the touch panel so that moisture and dust will invade into the touch panel. The conductive film and other conducting component might be corroded and cause signal transmission problem. Some touch panel uses special glue such as pressure sensitive adhesives which is capable of venting gas out of touch panel while suffering pressure. However, air can not come into the touch panel through the adhesives so that the upper and lower films will be pressed closer to each other by pressure and even cause a short. Such circumstance will cause even serious problem to popular large area touch panel.

### SUMMARY OF THE PRESENT INVENTION

Accordingly, the primary object of the present invention is to provide an air pressure balance structure for touch panel having a long narrow ventilating tunnel to communicate the inner space of the touch panel with the outside so as to prevent a damage caused by pressure difference. The ventilating tunnel will also prevent moisture and dust from coming into the touch panel to ensure the cleanliness inside the touch panel.

To achieve above object, the air pressure balance structure for touch panel is provided. The touch panel includes at least one resistive touch sensing unit, touch layer, substrate, and a gluing frame. The resistive touch sensing unit has two sheets of transparent conductive film. The two sheets of transparent conductive film are arranged with a predetermined gap. The upper conductive film is arranged to a surface of the transparent touch layer, and the lower conductive film is arranged to a surface of the transparent substrate. A plurality of protruding spacers is arranged between the two conductive films so that a space is formed within an effective area of the two conductive films. The gluing frame is arranged around the effective area so as to seal the substrate and the touch layer. A small ventilating tunnel is formed vertically to the gluing layer so that two ends of the ventilating tunnel are formed to two sides of the gluing layer. The air pressure inside and outside the touch panel can be balanced through the ventilating tunnel. A width of the ventilating tunnel is about 0.01 mm to 0.3 mm. By the long and narrow structure of the ventilating tunnel and the glue material of the gluing layer, moisture and dust will be prevented from coming into the touch panel.

At least one approximate N turning portion is formed along the ventilating tunnel. By the large containing space of the turning portion, air flow inside the tunnel is buffered and the moisture and dust can be stored within the containing space so as to prevent the moisture and dust coming into the touch panel.

### BRIEF DESCRIPTION OF THE DRAWINGS

FIG. 1 is a cross section view showing a first embodiment of the present invention.

FIG. 2 is a top view showing a gluing frame of the first embodiment of the present invention.

FIG. 3 is a cross section view showing a second embodiment of the present invention.

FIG. 4 is a top view showing the gluing frame of a third embodiment of the present invention.

FIG. 5 is a top view showing the gluing frame of a fourth embodiment of the present invention.

FIG. 6 is a top view showing the gluing frame of a fifth embodiment of the present invention.

FIG. 7 is a top view showing the gluing frame of a sixth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

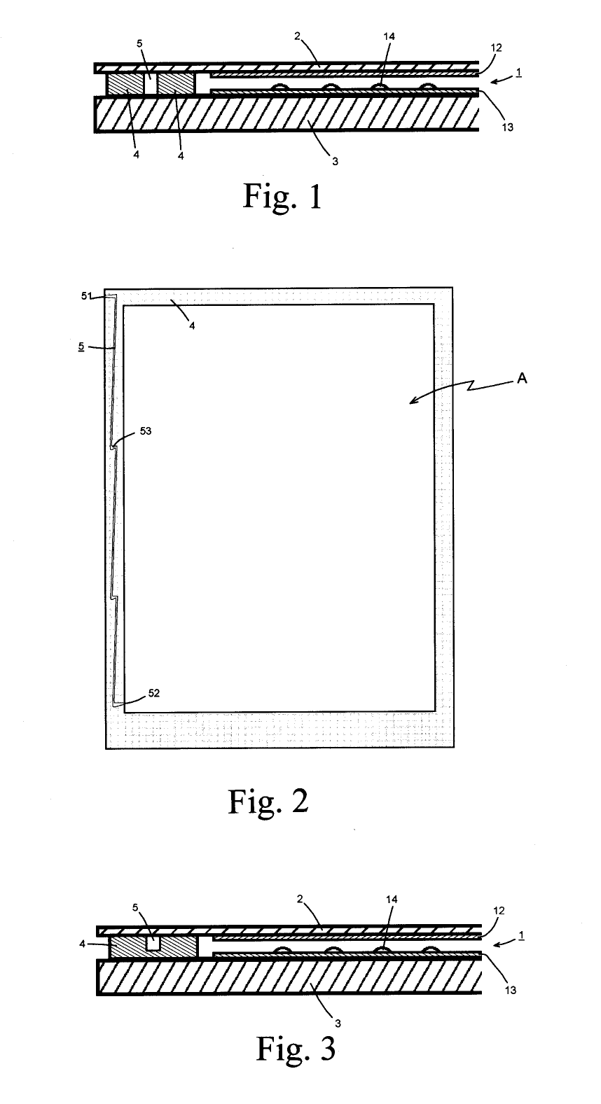

Referring to FIGS. 1 and 2, an embodiment of a resistive touch panel of the present invention includes a touch sensing unit 1, touch layer 2, substrate 3 and a gluing frame 4. The touch sensing unit 1 has two sheets of transparent conductive film 12 and 13 such as transparent Indium Tin Oxide (ITO) thin film. The touch layer 2 can be a transparent thin film such as a polycarbonate thin film. The substrate 3 is a transparent plate such as a thin glass or polymethyl methacrylate (PMMA) plate. The two sheets of transparent conductive film of the touch sensing unit 1 are arranged with a predetermined gap. The upper conductive film 12 is arranged to a surface of the transparent touch film, and the lower conductive film 13 is arranged to a surface of the transparent substrate 3. A plurality of protruding spacers 14 are arranged between the two conductive films 12 and 13 so that a space is formed within an effective area A of the two conductive films. The gluing frame 4 is arranged around the effective area A so as to glue the substrate 3 and the touch layer 2. Referring to FIG. 2, a small ventilating tunnel 5 is formed vertically to the gluing layer 4 so that two ends 51 and 52 of the ventilating tunnel 5 are formed to two sides of the gluing layer 4. The air pressure inside and outside the touch panel can be balanced through the ventilating tunnel 5. The ventilating tunnel 5 can be a gap formed in the middle of the gluing layer 4 as shown in FIG. 1 or a groove formed on a surface of the gluing layer 4 as shown in FIG. 3. A width of the ventilating tunnel 5 is about 0.1 mm. By the long and narrow structure of the ventilating tunnel 5 and the glue material of the gluing layer 4, moisture and dust will be prevented from coming into the effective area A within the conductive films. A plurality of approximate N turning portions 53 are formed along the ventilating tunnel 5 as shown in FIG. 2. By the large containing space of the turning portion 53, air flow inside the tunnel is buffered and the moisture and dust can be captured within the containing space so as to prevent the moisture and dust coming into the effective area A.

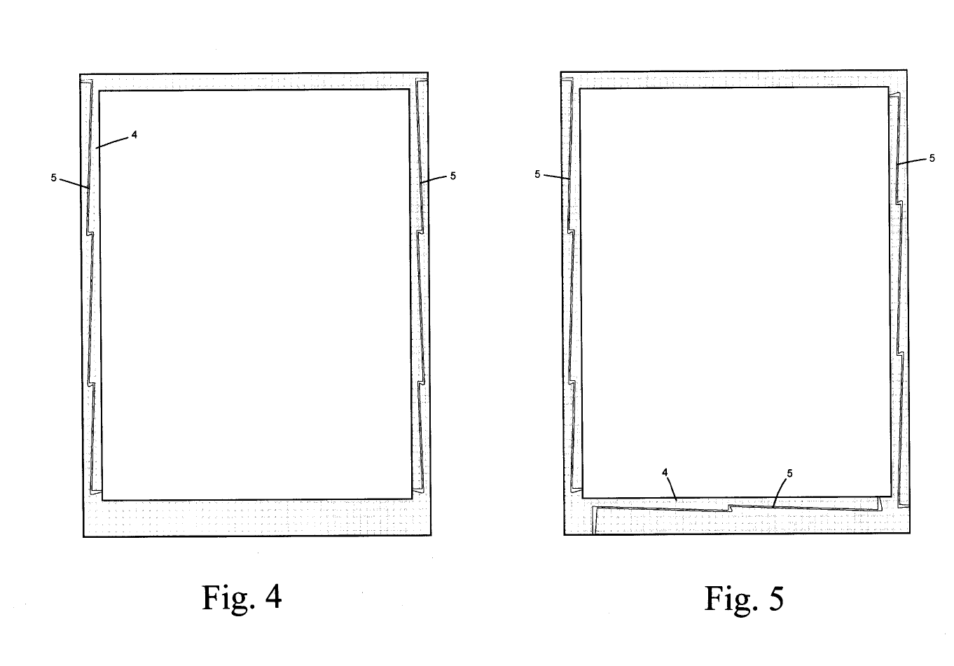

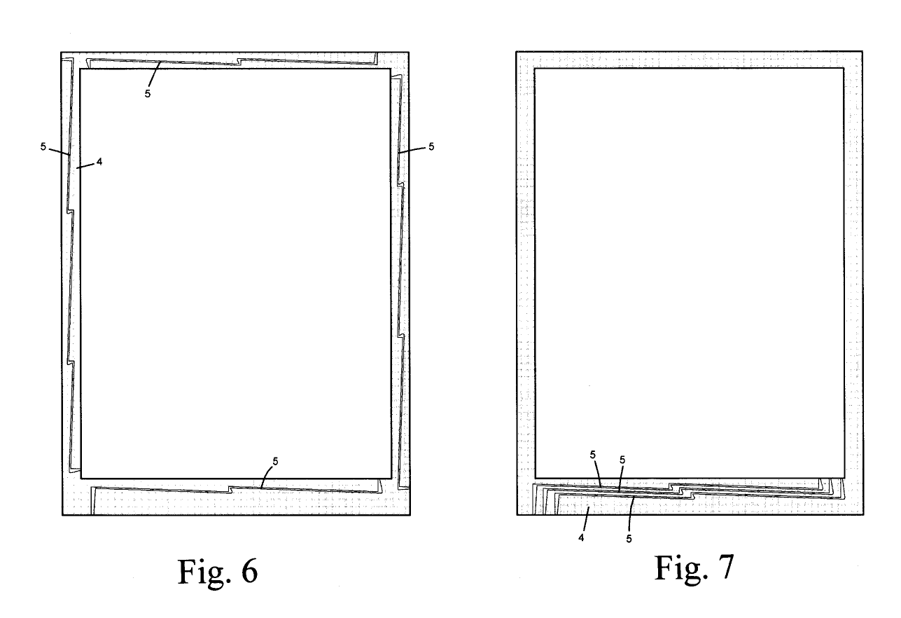

Referring to FIGS. 4 to 7, more embodiments of ventilating tunnel 5 are illustrated. By arranging multiple ventilating tunnels, a balance of air pressure will be quickly achieved. Such arrangement is suitable for large area touch panel such as two ventilating tunnels 5 on two lateral sides of the gluing frame 4 shown in FIG. 4, ventilating tunnels formed to the two lateral sides and bottom side of the gluing frame 4 shown in FIG. 5, or ventilating tunnels 5 formed to four sides of the gluing frame 4 shown in FIG. 6. Also, multiple ventilating tunnels 5 can be formed to one side of the gluing frame 4 as shown in FIG. 7.

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

What is claimed is:

1. An air pressure balance structure for touch panel comprising a resistive touch sensing unit, touch layer, substrate, and a gluing layer; the resistive touch sensing unit having two transparent conductive thin films arranged oppositely with a predetermined gap; the upper conductive film being arranged to a surface of the transparent touch film, and the lower conductive film being arranged to a surface of the transparent substrate; a plurality of protruding spacers being arranged between the two conductive films so that a space is formed within an effective area A of the two conductive films; the gluing frame being arranged around the effective area A so as to glue the substrate and the touch layer; at least one ventilating tunnel being formed vertically to a side of the gluing frame; two ends of the ventilating tunnel being formed to two edges of the side of the gluing frame so as to communicate the inner and the outer space of the touch panel.

2. The air pressure balance structure for touch panel as claimed in claim 1, wherein the long narrow ventilating tunnel has a width of 0.01 mm to 0.3 mm.

3. The air pressure balance structure for touch panel as claimed in claim 1, wherein at least one turning portion is formed to the ventilating tunnel.

4. The air pressure balance structure for touch panel as claimed in claim 3, wherein the turning portion has a large containing space.
